(19) United States
(12) Patent Application Publication
(10) Pub. No.: US 2006/0077473 A1
(43) Pub. Date: Apr. 13, 2006

(54) Computer device

(76) Inventor: Consie Chen, Taoyuan City (TW)

Correspondence Address: HARNESS, DICKEY & PIERCE, P.L.C., P.O. BOX 8910, RESTON, VA, 20195, US

(21) Appl. No.: 10/918,474

(22) Filed: Aug. 16, 2004

(51) Int. Cl. H04N 1/00

(52) U.S. Cl. 358/401

(57) ABSTRACT

A computer device includes a case forming a space for containing a plurality of electronic devices mounted therein, and a media inlet and a media outlet connected to the space. Particularly, a scanning/printing device is included in the space. The scanning/printing device comprises a scanning module for scanning the media and generating image data, a media transferring module had a media-feeding path connecting between the media inlet and the media outlet, and a printing module installed in a media-feeding path. The printing module prints according to the image data of the scanning module or the output data of the computer device.

### BACKGROUND OF THE INVENTION

1. Field of the Invention

The invention generally relates to a computer device, and in particular relates to a computer device, in which a multi-function scanner/printer is incorporated.

2. Related Art

Scanning and printing devices are now playing very important roles in our daily lives. Especially, in enterprises and offices, document saving and printing rely much on scanning and printing devices.

There are some designs of combing printing devices and data processing apparatuses in the world. For example, the POS (point of sale) systems in retail environments have printing devices in which data processing devices are incorporated. Some PDAs (personal digital assistants) also have printing functions for providing printouts of processed data. That kind of personal computer includes a printing device that is detachably installed in a hard disk peripheral slot, so that the data can be printed on a paper that is unwound from a paper roll installed in the device.

Although the aforesaid devices have printing capabilities, they have some drawbacks as follows. The POS systems work only for records of pricing and cash, and do not have data processing capabilities as general computers. The PDAs also have the same limitations. The computer with small printer is limited to the size of paper. Because the printer and paper roll are limited to the hard disk peripheral slot that is quite small and is incompatible with A3, A4 or B4 paper-size printings.

Currently, Office appliances, like copying machine, scanners, printers and fax machines have been replaced by MFPs (multi-function peripherals). Because the prices of the MFPs are getting lower and lower, consumers are very willing to buy the MFPs. Although the MFPs with copying, printing and scanning functions are convenient for users to use, the MFPs occupy too many additional spaces; moreover, data transmission cables between the MFPs and the computer device, and power supply cables will cause inconvenience in use, storage and moving.

### SUMMARY OF THE INVENTION

The object of the invention is to provide a computer device which incorporates functions of scanning, copying and printing.

A computer device according to the invention includes a case forming a space for containing a plurality of electronic devices mounted therein, and a media inlet and a media outlet connected to the space. Particularly, a scanning/printing device is included in the space. The scanning/printing device comprises a scanning module for scanning the documents to be scanned and for generating image data, and comprises a printing module installed in a media-feeding path connecting between the media inlet and the media outlet. The print module prints according to the image data generated by the scanning module or according to the processed data transmitted by the computer device.

The computer device of the invention directly provides functions of scanning, copying and printing, so as to save the space for additional device such a MFP. The space saving is important to a limited-space office environment. Also, there is no need of external wirings for the computer device. It gives cleanliness to the environment and convenience to the users.

### BRIEF DESCRIPTION OF THE DRAWINGS

The invention will become more fully understood from the detailed description given herein below. However, this description is for purposes of illustration only, and thus is not used to limit the invention, wherein:

FIG. 1A is an explanatory view of a computer device as a first embodiment of the invention;

FIG. 1B is a partially sectional view of a first embodiment of the invention;

FIG. 2 is a an explanatory view of a computer device as a second embodiment of the invention;

FIG. 3A is a an explanatory view of a computer device as a third embodiment of the invention;

FIG. 3B is a partially sectional view of a third embodiment of the invention; and

### DETAILED DESCRIPTION OF THE INVENTION

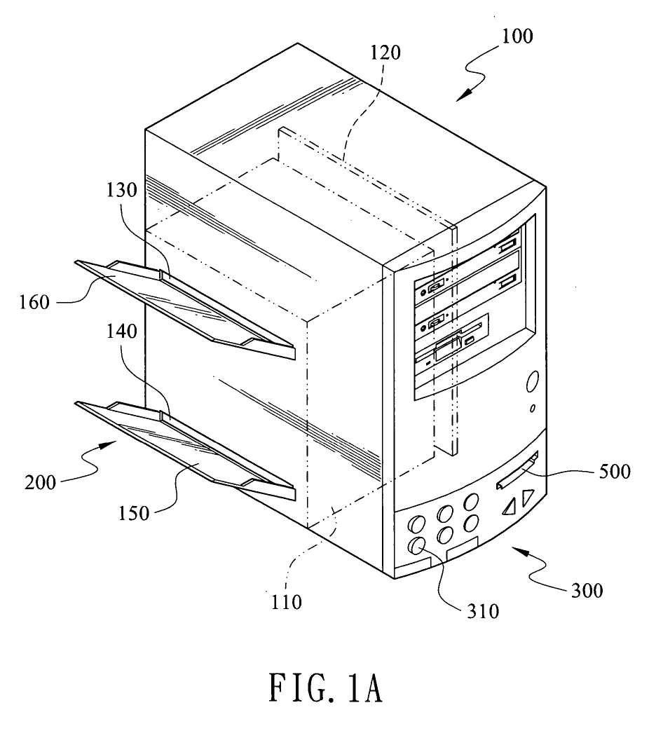

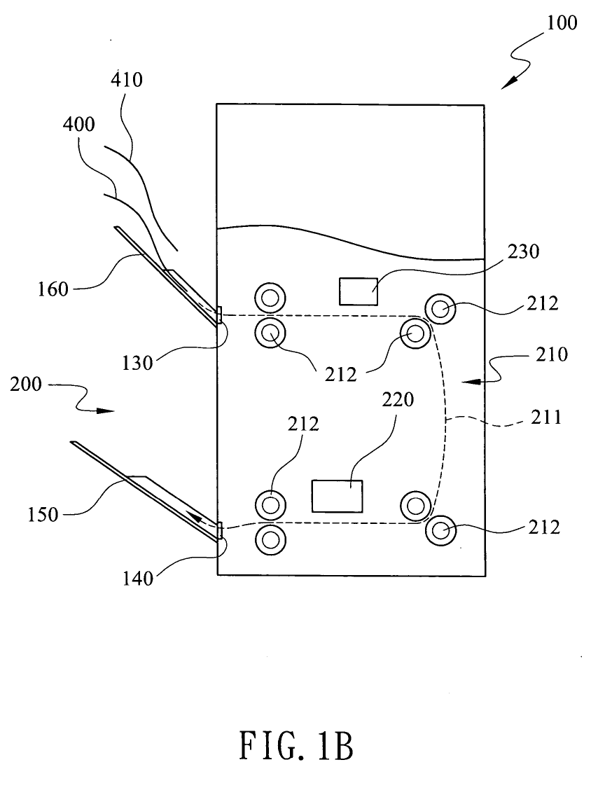

As shown in FIGS. 1A and 1B, a computer device includes a case 100 forming a space 110 for containing a scanning/printing device 200 and a plurality of electronic devices 120. A media inlet 130 and a media outlet 140 are connected to the space 110. There are media trays 160, 150 which are correspond to the media inlet 130 and the media outlet 140 for holding the media 400 to be transferred and already processed. The electronic devices 120 in the space are main board, CPU, memories, video graphic card, etc. of the computer, which are not the object of the invention, and thus, will not be described in detail hereinafter.

The scanning/printing device 200 is mounted in a lower portion of the case 100 and comprises a media-transferring module 210, a printing module 220 and a scanning module 230 in which the media-transferring module 210 includes a media-feeding path 211 connecting between the media inlet 130 and the media outlet 140, and there are feeding rollers 212 mounted on the media-feeding path 211 for transferring the media 400 or the document 410 to be scanned. The scanning module 230 and the printing module 220 are located, along with the media-feeding path 211 of the media 400, on suitable positions. The scanning module 230 scans the document 410 transferred by the media-transferring module 210, and generates image data. The printing module 220 prints on the media 400 according to the image data generated by the scanning module 230 or to the processed data transmitted by the computer device. The rollers 212 of the media-transferring module 210 transfers the media 400 toward the media outlet 140 and the tray 150. There is a control module 300 mounted on one side of the case 100. The control module 300 includes a plurality of buttons 310 for users to operate the scanning/printing device 200, and an expansion slot 500 for receiving an memory card (not shown) that stores data for the scanning/printing device 200 to print.

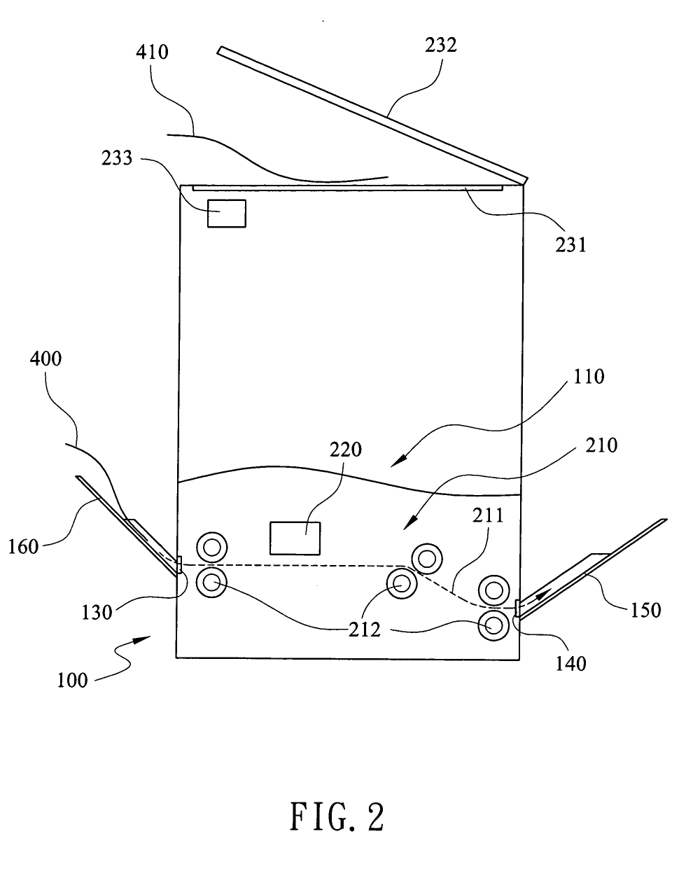

FIG. 2 shows a second embodiment of the invention. A scanning/printing device 200 is mounted in the lower portion of the space 110 inside the case 100. However, the location of the scanning/printing device 200 is not limited to the lower or upper position. A media inlet 130 and the media outlet 140 are located on two sides of the case 100. A media-transferring module 210 connects between the media inlet 130 and the media outlet 140 to form a media-feeding path 211, and includes a plurality of feeding rollers 212. A printing module 220 is located, along with the media-feeding path 211 of the media 400, in a suitable position. The scanning module of the scanning/printing device 200 is located on top of the computer device, and comprises a flatbed 231, a lid 232 and a scanning unit 233. The lid 232 is pivotally mounted on top of the case 100 for covering the document 410 placed on top of the flatbed 231 during scanning. The scanning unit 233 is mounted under the flatbed 231 for scanning the document 410 and generating image data. The media-transferring module 210 transfers the media 400 from the media tray 160 through the media inlet 130. The media 400 are printed by the printing module 220 according to the scanned image data or to the data processed by the computer device, and finally transferred through the media outlet 140 to the tray 150.

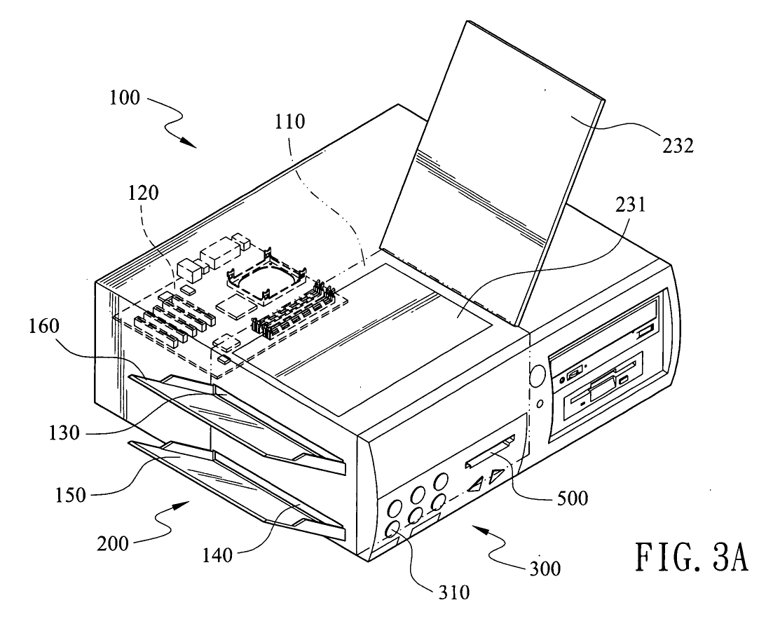

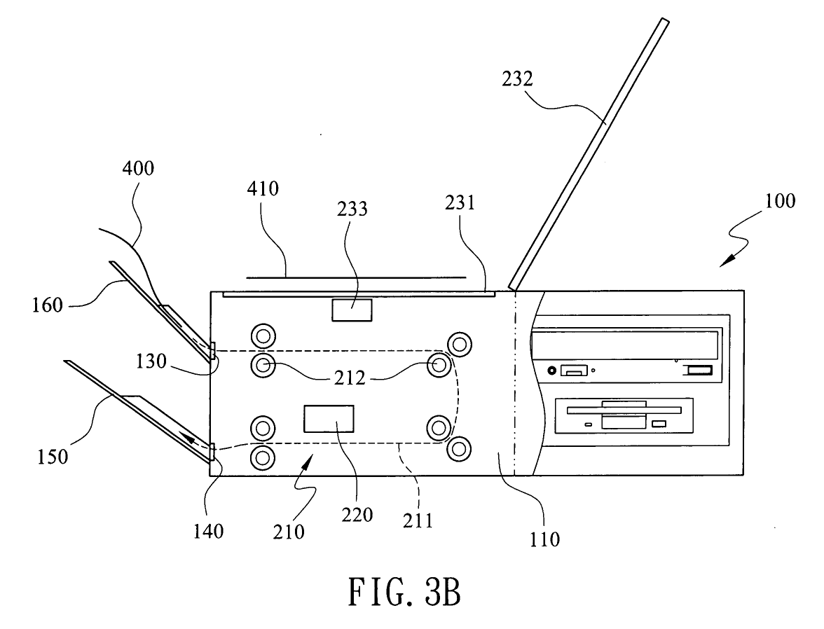

Beside the aforesaid two embodiments of vertical component arrangement of the invention, a horizontal arrangement as shown in FIGS. 3A and 3B is also practical. A scanning/printing device 200 is mounted on front portion of the space 110. A control module 300 is located on front side of the case 100, and includes buttons 310 for users to operate. An expansion slot 500 for receiving a memory card as described above is also provided. A scanning module 230 including a flatbed 231, a lid 232 and a scanning unit 233 as described above is mounted on top of the case 100. A media-transferring module 210 transfers the media 400 from the media tray 160 through the media inlet 130. The media 400 are printed by the printing module 220 according to the scanned image data or the data processed by the computer device, and finally transferred through the media outlet 140 to the tray 150.

As described above, the computer device of the invention includes not only basical electronic components of computer but also a scanning/printing device for providing printing, scanning and copying functions besides data processing of general computers. The printing and scanning is applicable to common A3, A4 or B4 paper size. The computer device with scanning/printing device is easy to install, use and move.

The invention being thus described, it will be obvious that the same may be varied in many manners. Such variations cannot be regarded as departing from the spirit and scope of the invention, and all such modifications as would be obvious to one skilled in the art are intended to be included within the scope of the following claims.

What is claimed is:

1. A computer device, comprising:
a case forming a space for containing a plurality of electronic devices mounted therein, and a media inlet and a media outlet connected to said space; and
a scanning/printing device mounted in said space and comprising a scanning module for scanning an object to be scanned and for generating image data, and a printing module installed in a media-feeding path of a media-transferring module connecting between said media inlet and said media outlet; said printing module prints according to said image data of said scanning module and data of said computer device.

2. The computer device according to claim 1 wherein said scanning module comprises a movable lid, a flatbed and a scanning unit; said lid is pivotally mounted upon said flatbed for covering a document placed on said flatbed when scanning; said scanning unit is mounted under said flatbed for scanning said document and generating image data to be processed by said computer device.

3. The computer device according to claim 1 wherein said media-transferring module comprises a plurality of feeding rollers for transferring said media.

4. The computer device according to claim 1 further comprises a control module mounted on said case and comprising a plurality of buttons for users to operate said scanning/printing device.

5. The computer device according to claim 1 wherein said media inlet and said media outlet are located on one side of said case.

6. The computer device according to claim 1 wherein said media inlet and said media outlet are located on two sides of said case.

7. The computer device according to claim 1 wherein said scanning/printing device is mounted in a lower portion of said space.

8. The computer device according to claim 1 wherein said scanning/printing device is mounted in an upper portion of said space.

9. The computer device according to claim 1 further comprises an expansion slot electrically connected to said computer device for receiving a memory card storing data to be processed by said computer device.

10. The computer device according to claim 1 further comprises a media tray mounted aside said media inlet for storing media to be transferred.

11. The computer device according to claim 1 further comprises a media tray mounted aside said media outlet for storing media after being processed.
